(19) United States
(12) Patent Application Publication
(10) Pub. No.: US 2018/0319974 A1
(43) Pub. Date: Nov. 8, 2018

(54) AQUEOUS COMPOSITIONS BASED ON POLYALKENAMERS

(71) Applicant: BASF SE, Ludwigshafen am Rhein (DE)

(72) Inventors: Theo SMIT, Ludwigshafen (DE); Norma Lidia NEGRETE HERRERA, Ludwigshafen (DE); Stefan DAHMEN, Ludwigshafen (DE); Bernhard STURM, Ludwigshafen (DE); Kevin MUELLER, Ludwigshafen (DE); Karl HAEBERLE, Ludwigshafen (DE)

(73) Assignee: BASF SE, Ludwigshafen am Rhein (DE)

(21) Appl. No.: 15/775,140

(22) PCT Filed: Nov. 11, 2016
(86) PCT No.: PCT/EP2016/077403

§ 371 Date: May 10, 2018

(30) Foreign Application Priority Data
Nov. 13, 2015 (EP) 15194540.9

(51) Int. Cl. C08L 65/00; C08G 61/08; C08L 75/04

(52) U.S. Cl. CPC C08L 65/00; C08G 61/08; C08G 2261/60; C08G 2261/418; C08L 75/04

(57) ABSTRACT

The invention relates to aqueous compositions comprising
a) at least one polymer PALK in the form of dispersed polymer particles, wherein the polymer PALK is obtainable by ring-opening metathesis polymerization of at least one cyclic olefin monomer, and
b) at least one polymer P2 in the form of dispersed polymer particles, wherein the polymer P2 comprises no olefinically unsaturated C—C-bond and has repeating units bearing at least one polar group.

The aqueous compositions are suitable in particular for producing sheetings and barrier coatings having a very good barrier action toward gases, such as air, oxygen, nitrogen, argon, carbon dioxide, and in particular toward oxygen and oxygenous gases, such as air. The sheetings and coatings also have very good mechanical properties, in particular a high elongation at break coupled with good tear strength.

The present invention relates to aqueous compositions based on polyalkenamers and the use thereof as barrier coatings.

### BACKGROUND OF THE INVENTION

In the field of pneumatic vehicle tires it is important to ensure that the compressed air or the fill gas provides functional tire operation with the required pressure and the necessary gas volume for the longest possible time. Conventional pneumatic tires therefore typically have a gas-impermeable rubber layer in the tire interior. This tire inner layer seals the gas-filled interior and in tubeless tires replaces the tube. A pneumatic vehicle tire is moreover typically constructed from a plurality of materials and also comprises metallic constituents, for example as the carcass material. Some of these materials and tire ingredients are oxidation-sensitive. Thus the tire inner layer also protects the tire materials and ingredients from oxidation. Due to the high mechanical stresses to which vehicle tires are subjected the materials employed need to exhibit suitable mechanical properties, in particular a good extensibility.

Barrier coatings hitherto employed in vehicle tires are halobutyl rubbers and mixtures comprising butyl rubbers. These have the disadvantage that sufficient gas barrier properties may be achieved only through a thick coating which is disadvantageous for the weight of the tire. The materials are moreover costly with limited market availability.

U.S. Pat. No. 4,025,708, EP 1932688 A1, U.S. Pat. No. 8,541,527 B2, and U.S. Pat. No. 3,778,420 describe the use of polyalkenamers in rubber materials. The polyalkenamers employed are unoxidized. EP 1932688 describes run-flat tires comprising elastomer layers comprising polyalkenamers.

WO 2012/028530, WO2012/107418 and WO 2014/0268865 describe the use of aqueous dispersions of polyalkenamers for producing barrier coatings on rubber materials.

EP 1664183 B1 describes mixtures of polyurethane dispersions and latex dispersions. The films produced from these mixtures are used as gas barriers, the barrier being generated by the polyurethane. The best latex/polyurethane mixture has a permeation of 1.5*10⁻⁵ (cm³ mm)/(m² h Pa). This corresponds to 36 (cm³ mm)/(m² day bar).

### SUMMARY OF THE INVENTION

The present invention has for its object the provision of compositions suitable for producing coatings or sheetings having good barrier properties, in particular having a low permeability for nonpolar gases such as oxygen. The compositions shall be stable. The compositions shall moreover be suitable for producing films/sheetings and coatings. Production shall in particular be simple, economic and robust. The films/sheetings and coatings produced from the compositions shall have advantageous mechanical properties, in particular a good extensibility and a low brittleness. The films and coatings produced from the compositions shall in particular exhibit an advantageous barrier action toward gases, preferably a good oxygen barrier action, coupled with advantageous mechanical properties, preferably a low brittleness and a high elongation at break.

These and further objects are achieved by the aqueous compositions described hereinbelow.

The invention provides aqueous compositions comprising
a) at least one polymer PALK in the form of dispersed polymer particles, wherein the polymer PALK is obtainable by ring-opening metathesis polymerization of at least one cyclic olefin monomer, and
b) at least one polymer P2 in the form of dispersed polymer particles, wherein the polymer P2 comprises no olefinically unsaturated C—C-bond and has repeating units bearing at least one polar group.

The aqueous compositions are suitable in particular for producing sheetings and barrier coatings having a very good barrier action toward gases, such as air, oxygen, nitrogen, argon, carbon dioxide, and in particular toward oxygen and oxygenous gases, such as air. The sheetings and coatings also have very good mechanical properties, in particular a high elongation at break coupled with good tear strength.

The invention accordingly also relates to the use of the aqueous compositions according to the invention for producing barrier sheetings and barrier coatings, in particular on rubber materials.

The invention also relates to coatings obtainable by a process comprising (a) applying an aqueous composition according to the invention to the surface of a sheetlike carrier and (b) removing the volatile constituents of the composition to obtain a coating.

The invention further relates to polymer sheetings produced using an aqueous composition according to the invention and producible in particular by drying a film of the aqueous polymer composition comprising at least one polymer PALK and at least one polymer P2.

The invention further provides a polymer powder obtainable by drying an aqueous composition according to the invention.

The invention further provides a process for producing the aqueous compositions according to the invention comprising mixing at least one aqueous dispersion PALK-D comprising at least one polymer PALK with at least one aqueous dispersion P2-D comprising at least one polymer P2.

### DETAILED DESCRIPTION OF THE INVENTION

In the context of the invention the term polymer encompasses not only homopolymers but also co- and terpolymers

In the context of the invention the term polymer dispersion refers to an aqueous dispersion of polymer particles of the same or different types in a liquid phase in which the polymer is insoluble. In addition to the polymer particles a polymer dispersion may have further constituents, for example surface-active compounds, emulsifiers, stabilizers or other compounds.

Useful as the liquid phase are not only water but also mixtures of water comprising one or more water-miscible organic solvents in which, however, water is the main constituent of the mixture and preferably accounts for at least 80 wt %, in particular at least 90 wt %, based on the total amount of the solvent. A water-miscible organic solvent typically has a solubility in water at 25° C. and 1 bar of at least 100 g/L. Examples of watermiscible organic solvents especially include alkanols having 1 to 6 carbon atoms such as methanol, ethanol, propanol, isopropanol, n-butanol, 2-butanol and tert-butanol and also polyhydric alcohol such as ethylene glycol, propylene glycol, butanediol and glycerol.

In the context of the invention the term polymer particles describes particles of one or more polymers, wherein in the case where the polymer particle is constructed from a plurality of polymers said polymers may be of the same or different types.

The term barrier coatings is to be understood as meaning coatings on a surface of a carrier which confer upon the carrier an improved barrier action, in particular toward gases, such as air, oxygen, nitrogen, argon, carbon dioxide, and in particular toward oxygen and oxygenous gas mixtures, for example air.

The term barrier sheetings is to be understood as meaning sheetings comprising at least one layer which confer upon the sheeting an improved barrier action, in particular toward gases, such as air, oxygen, nitrogen, argon, carbon dioxide, and in particular toward oxygen and oxygenous gases, such as air.

The aqueous compositions according to the invention comprise as the first constituent at least one polymer PALK. This is present in the aqueous composition in the form of polymer particles. The polymer particles of the polymer PALK preferably have a volume-average particle size determined by analytical ultracentrifugation (AUC) in the range from 200 to 1000 nm, preferably from 200 to 500 nm.

The polymer PALK preferably has a density in the range from 0.75 to 0.97 g/cm³, particularly preferably in the range from 0.85 to 0.97 g/cm³, determined by H₂O-D₂O sedimentation analysis (HDA).

The density and the average particle diameter of the particles may be determined, for example, by analytical ultracentrifugation (AUC) with turbidity optics as described in “Analytical Ultracentrifugation of polymers and nanoparticles” (Springer Laboratory 2006, W. Mächtle and L. Borger). Density determination comprises measuring sedimentation rates under otherwise identical conditions in three solvents of different densities (H₂O, H₂O/D₂O (1:1) and D₂O). Particle size may be determined from the sedimentation rate.

Particle size may also be determined as described in ISO 13318. In density determination by HDA the analysis of sedimentation in H₂O and D₂O may be performed with the same centrifuge and the same optics. Those skilled in the art can tailor the analysis to determine density.

The polymer PALK preferably has a glass transition temperature Tg determined by differential scanning calorimetry DSC in the range from −100° C. to −20° C., particularly preferably in the range from −90° C. to −30° C. Glass transition temperature (Tg) was determined using a TA Instruments DSC Q2000 V24.4 Build 116 differential scanning calorimeter. A heating rate of 20 K/min was employed. Measurement may be taken as per DIN ISO 11352-2 or a variation thereof.

In one preferred embodiment of the invention the polymer PALK in the barrier sheeting or barrier coating is in at least partly oxidized form. The term “oxidized” is to be understood as meaning that the polymer PALK bears at least one oxygen-containing group.

The degree of oxidation of the polymers may be determined by infrared spectroscopy. Suitable therefor are, for example, the C═O, C—O and OH signals. The degree of oxidation may preferably be calculated as the quotient of the extinctions for the carbonyl group and for the C—C double bond.

Oxidation of the polyamide PALK may be effected, for example, by storage in an oxygenous environment, preferably while employing radiant energy, thermal energy or oxidation accelerants or a combination thereof. Oxidation of the polymer PALK may be effected, for example, in air under daylight at room temperature (ca. 20-25° C.). Oxidation may be accelerated by radiant energy, thermal energy or oxidation accelerants. Useful oxidation accelerants include, for example, chemical oxidation accelerants such as transition metals and transition metal compounds known for this purpose, in particular those of iron, zirconium, manganese, zinc or cobalt.

In one embodiment the aqueous polymer composition comprising at least one polymer PALK and at least one polymer P2 comprises at least one oxidation accelerant. This oxidation accelerant is preferably selected from transition metal compounds, in particular from Zr-containing compounds, Zn-containing compounds and Co-containing compounds and mixtures thereof, for example Octa-Soligen® 144 aqua and Octa-Soligen® 141 Z from OMG Borchers.

The polymers PALK, their aqueous dispersions and processes for producing the dispersions are known, for example from WO 2011/051374, WO 2012/028530, WO 2012/076426, WO2012/107418 and WO 2014/0268865 and from the literature cited therein. The aqueous dispersions of the polymers PALK employed in accordance with the invention may be produced as per the methods described therein by ring opening metathesis polymerization of cyclic olefins.

The term metathesis reaction is to be understood in very general terms as meaning a chemical reaction between two compounds where one group is exchanged between both reactants. When an organic metathesis reaction is concerned the substituents at a double bond are formally exchanged. However, of particular importance is the metal-complex-catalyzed ring-opening metathesis reaction of organic cycloolefin compounds, ROMP for short, which provides a route to polyalkenamers. The catalytic metal complexes employed are in particular metal carbene complexes having the general structure Met=CR₂ where R represents an organic radical. Due to the high sensitivity of the metal carbene complexes to hydrolysis the metathesis reactions may be carried out in water-free organic solvents or in the olefins themselves (see by way of example US-A 2008234451, EP-A 0824125). To avoid complex purification steps for removing large amounts of solvent or of unconverted olefins the metathesis reaction of olefins may also be carried out in aqueous medium (DE 19859191; U.S. patent application 61/257,063, WO 2011/051374, WO 2012/028530, WO 2012/076426, WO2012/107418 and WO 2014/0268865).

The polyalkenamers PALK are generally obtainable by ring-opening metathesis polymerization of at least one cyclic olefin monomer O comprising at least one endocyclic double bond.

The cyclic olefin monomer O typically comprises at least one 5- to 12-membered carbon ring comprising an endocyclic double bond which may have either a cis- or trans-configuration. The carbon ring of the olefin monomer O may be substituted by one or more, for example 1, 2, 3, 4, 5 or 6, C₁-C₆-alkyl groups or C₃-C₆-cycloalkyl groups, for example by methyl or ethyl groups. The cyclic olefin monomer may also comprise one or more, for example 1, 2, or 3 further carbon rings which in turn may comprise an endocyclic double bond and/or may be substituted by one or more, for example 1, 2, 3, 4, 5 or 6, C₁-C₄-alkyl groups, for example by methyl or ethyl groups.

Typical olefin monomers O are preferably pure hydrocarbons which are preferably not substituted with heteroatoms.

25

Examples of olefin monomers O include cyclopentene, 1,3-cyclopentadiene, dicyclopentadiene (3a,4,7,7a-tetrahydro-1H-4,7-methanoindene), 2-methylcyclopent-1-ene, 3-methylcyclopent-1-ene, 4-methylcyclopent-1-ene, 3-butylcyclopent-1-ene, vinylcyclopentane, cyclohexene, 2-methylcyclohex-1-ene, 3-methylcyclohex-1-ene, 4-methylcyclohex-1-ene, 1,4-dimethylcyclohex-1-ene, 3,3,5-trimethylcyclohex-1-ene, 4-cyclopentylcyclohex-1-ene, vinylcyclohexane, cycloheptene, 1,2-dimethylcyclohept-1-ene, cis-cyclooctene, trans-cyclooctene, 2-methylcyclooct-1-ene, 3-methylcyclooct-1-ene, 4-methylcyclooct-1-ene, 5-methylcyclooct-1-ene, cycloocta-1,5-diene, cyclononene, cyclodecene, cycloundecene, cyclododecene, bicyclo[2.2.1]hept-2-ene, 5-ethylbicyclo[2.2.1]hept-2-ene, 2-methylbicyclo[2.2.2]oct-2-ene, bicyclo[3.3.1]non-2-ene and bicyclo[3.2.2]non-6-ene. It will be appreciated that mixtures of the abovementioned monomers may also be employed in accordance with the invention.

The olefin monomers O preferably comprise
a) at least one first olefin monomer O1 selected from the group consisting of monocyclic olefin monomers having at least one endocyclic C—C double bond, there being no hydrogen-bearing tertiary carbon atom in the alpha position to the double bond, and
b) optionally one or more further olefin monomers O2 selected from the group consisting of
   monocyclic olefin monomers O2.1 having an endocyclic double bond, there being a hydrogen-bearing tertiary carbon atom in at least one alpha position to the double bond;
   bicyclic olefin monomers O2.2 having at least one endocyclic double bond and two hydrocarbon rings,
   polycyclic olefin monomers O2.3 having at least one endocyclic double bond and at least 3, for example 3 or 4, hydrocarbon rings.

The olefin monomer O1 preferably accounts for at least 20 wt %, in particular at least 50 wt %, based on the total amount of the olefin monomers O. The at least one olefin monomer O1 may be the sole monomer.

In one preferred embodiment the olefin monomer O comprises at least one olefin monomer O1 and at least one olefin monomer O2. In this embodiment the molar ratio of olefin monomers O1 to olefin monomers O2 is generally in the range from 99:1 to 1:99, preferably in the range from 90:10 to 10:90, particularly preferably in the range from 50:50 to 80:20.

Examples of olefinic monomers O1 include cyclobutene, cyclopentene, 2-methylcyclopent-1-ene, 4-methylcyclopent-1-ene, cyclohexene, 2-methylcyclohex-1-ene, 4-methylcyclohex-1-ene, 1,4-dimethylcyclohex-1-ene, cycloheptene, 1,2-dimethylcyclohept-1-ene, cis-cyclooctene, trans-cyclooctene, 2-methylcyclooct-1-ene, 4-methylcyclooct-1-ene, 5-methylcyclooct-1-ene, cyclononene, cyclodecene, cycloundecene, cyclododecene, cyclooctadiene, cyclopentadiene and cyclohexadiene, particular preference being given to monocyclic olefins having a C—C double bond, in particular cis-cyclooctene.

Preferred monomers O2.1 are 3-alkylcycloalk-1-enes having preferably 1 to 10 or 1 to 4 carbon atoms in the alkyl group and preferably 5 to 8 carbon atoms in the cycloalkene ring. Suitable compounds include, for example, 3-methylcyclopent-1-ene, 3-butylcyclopent-1-ene, 3-methylcyclohex-1-ene, 3-methylcyclooct-1-ene, 3-propylcyclopent-1-ene, 3-methylcyclooct-1-ene and 3,3,5-trimethylcyclohex-1-ene.

Examples of bicyclic olefins O2.2 include norbornene (=bicyclo[2.2.1]hept-2-ene) and bicyclo[2.2.2]oct-2-ene, 5-ethylbicyclo[2.2.1]hept-2-ene, 2-methylbicyclo[2.2.2]oct-2-ene, bicyclo[3.3.1]non-2-ene or bicyclo[3.2.2]non-6-ene. A preferred olefin O2.2 is norbornene.

An example of a polycyclic olefin O2.3 is dicyclopentadiene (=3a,4,7,7a-tetrahydro-1H-4,7-methanoindene).

In one embodiment of the invention no polycyclic dienes O2.3 are employed as olefin monomer b).

In one preferred embodiment the polymers PALK are formed by ring-opening metathesis polymerization of cis-cyclooctene or a mixture of cis-cyclooctene and norbornene or a mixture of cis-cyclooctene and dicyclopentadiene.

The production of the polymers PALK is preferably carried out as an emulsion polymerization or miniemulsion polymerization in aqueous medium in the presence of a carbene complex suitable for metathesis polymerization according to a prior art process, for example according to the processes described in WO 2011/051374, WO 2012/028530, WO 2012/076426, WO2012/107418 and WO 2014/0268865, the disclosure of which is hereby expressly incorporated herein by reference.

For example the ring-opening metathesis reaction of the olefin monomers may be carried out such that it comprises initially charging water and optionally dispersant into a polymerization vessel, dissolving an organometallic carbene complex employed as catalyst in the olefin or olefin mixture to be polymerized or in a mixture of olefin and an organic solvent, introducing the olefin/carbene complex solution into the aqueous dispersant solution, optionally converting the thus formed olefin/carbene complex macroemulsion into a miniemulsion and reacting the macroemulsion or miniemulsion at polymerization temperature to afford an aqueous polyolefin dispersion.

Another possible procedure comprises emulsifying in water or a mixture of water and dispersant the olefin or olefin mixture to be polymerized or a mixture of olefin and an organic solvent, optionally converting the thus formed macroemulsion into a miniemulsion and adding the macroemulsion or miniemulsion, by addition of an organometallic carbene complex suitable for metathesis polymerization, for example in the form of an aqueous solution of a water-soluble carbene complex, to the macro- or miniemulsion and reacting said emulsion to afford an aqueous polyolefin dispersion.

The ring opening metathesis reaction is preferably carried out such that it comprises initially charging at least some of the water, at least some of the dispersant and at least some of the monomers in the form of an aqueous monomer macroemulsion having an average droplet diameter of ≥2000 nm, then converting the monomer macroemulsion by input of energy, for example by means of ultrasound or by means of high-pressure homogenization, into a monomer miniemulsion having an average droplet diameter of ≤1500 nm, in particular ≤1000 nm, and then adding to the obtained monomer miniemulsion at polymerization temperature and preferably in the form of an aqueous solution any remaining residual amount of the dispersant, any remaining residual amount of the monomers and the total amount of an organometallic carbene complex employed as catalyst.

Useful metathesis catalysts are organometallic carbene complexes. The metals are, for example, transition metals of transition groups 5, 6, 7 or 8, preferably tantalum, molybdenum, tungsten, osmium, rhenium or ruthenium, with osmium and ruthenium being preferred among these. Ruthenium-alkylidene complexes are employed with particular preference. Such metathesis catalysts are known from the prior art and are described, for example, in Grubbs (Ed.) “Handbook of Metathesis”, 2003, Wiley-VCH, Weinheim, WO 93/20111, WO 96/04289, WO 97/03096, WO 97/06185, J. Am. Soc. 1996, pp. 784-790, Dalton Trans. 2008, pp. 5791-5799 and in Coordination Chemistry Reviews, 2007, 251, pp. 726-764. The water-soluble carbene complexes referred to in WO 2011/051374 and WO 2012/076425 in particular are suitable and are hereby expressly incorporated herein by reference.

Suitable dispersants include, for example, those referred to in WO 2011/051374 and WO 2012/076425. Useful dispersing aids include both the neutral, anionic or cationic protective colloids typically employed for carrying out free-radical aqueous emulsion polymerizations and anionic or nonionic emulsifiers.

Preferred dispersants comprise at least one nonionic emulsifier. Examples of nonionic emulsifiers include ethoxylated mono-, di- and trialkylphenols (degree of ethoxylation: 3 to 50, alkyl radical: C₄ to C₁₂) and ethoxylated fatty alcohols (degree of ethoxylation: 3 to 80; alkyl radical: C₆ to C₃₆). Examples thereof include the Lutensol® A brands (C₁₂C₁₄-fatty alcohol ethoxylates, degree of ethoxylation: 3 to 8), Lutensol® AO brands (C₁₃C₁₅-oxoalcohol ethoxylates, degree of ethoxylation: 3 to 30), Lutensol® AT brands (C₁₆C₁₈-fatty alcohol ethoxylates, degree of ethoxylation: 11 to 80), Lutensol® ON brands (C₁₀-oxoalcohol ethoxylates, degree of ethoxylation: 3 to 11) and the Lutensol® TO brands (C₁₃-oxoalcohol ethoxylates, degree of ethoxylation: 3 to 20) from BASF SE. It is alternatively possible to employ low molecular weight, random and water-soluble ethylene oxide and propylene oxide copolymers and derivatives thereof, low molecular weight, water-soluble ethylene oxide and propylene oxide block copolymers (for example Pluronic® PE having a molecular weight of 1000 to 4000 g/mol and Pluronic® RPE from BASF SE having a molecular weight of 2000 to 4000 g/mol) and derivatives thereof.

To produce the polymers PALK by emulsion polymerization or miniemulsion polymerization in aqueous medium it may be advantageous to employ one or more organic solvents which even under polymerization conditions (at a given pressure and a given temperature) exhibit low water-solubility, i.e. a solubility of ≤10 g, advantageously ≤1 g and particularly advantageously ≤0.2 g per liter of deionized water. The organic solvents may serve both to dissolve the monomers and thus reduce the concentration thereof in the macro/miniemulsion droplets and to ensure the stability of the thermodynamically unstable miniemulsion droplets (by preventing so-called Ostwald ripening).

Suitable organic solvents include in particular liquid aliphatic and aromatic hydrocarbons having 5 to 30 carbon atoms, for example n-pentane and its isomers, cyclopentane, n-hexane and its isomers, cyclohexane, n-heptane and its isomers, n-octane and its isomers, n-nonane and its isomers, n-decane and its isomers, n-dodecane and its isomers, n-tetradecane and its isomers, n-hexadecane and its isomers, n-octadecane and its isomers, benzene, toluene, ethylbenzene, cumene, o-, m- or p-xylene, and in general hydrocarbon mixtures in the boiling range of 30° C. to 250° C. Likewise useful are esters, for example fatty acid esters having 10 to 28 carbon atoms in the acid portion and 1 to 10 carbon atoms in the alcohol portion or esters of carboxylic acids and fatty alcohols having 1 to 10 carbon atoms in the carboxylic acid portion and 10 to 28 carbon atoms in the alcohol portion. It will be appreciated that mixtures of the abovementioned solvents may also be employed. The organic solvent is advantageously selected from the group comprising n-hexane, n-octane, n-decane, n-tetradecane, n-hexadecane, and the isomeric compounds thereof, benzene, toluene and/or ethylbenzene. It is alternatively possible, similarly to the abovementioned organic solvents, to employ water-insoluble oligomers or polymers which even under polymerization conditions (at a given pressure and a given temperature) exhibit low water-solubility, i.e. a solubility of ≤10 g, advantageously ≤1 g and particularly advantageously ≤0.2 g per liter of deionized water to prevent Ostwald ripening. Suitable substances here include, for example, polystyrene, polystearyl acrylate, polybutadiene, polyisobutylene, polynorbornene, polyoctenamer, polydicyclopentadiene and styrene-butadiene rubber.

For further details concerning the production of the aqueous dispersions of the polyalkenamer PALK reference is made to the processes described in WO 2011/051374, WO 2012/028530, WO 2012/076426, WO2012/107418 and WO 2014/0268865, the disclosure of which is hereby expressly incorporated herein by reference.

The aqueous compositions according to the invention further comprise at least one polymer P2 which in the repeating units comprises at least one polar group and no unsaturated C—C bond. The polymer P2 is likewise present in the aqueous composition in the form of polymer particles.

The polymer P2 is preferably in the form of polymer particles having an average particle size determined by analytical ultracentrifugation (AUC) in the range from 20 to 500 nm, preferably from 30 to 250 nm.

The polymer P2 preferably has a density in the range from 1.0 to 1.5 g/cm³, particularly preferably in the range from 1.05 to 1.20 g/cm³, determined by H2O-D2O sedimentation analysis.

The polymer P2 preferably has at least a glass transition temperature Tg determined by dynamic scanning calorimetry, DSC, in the range from −70° C. to 30° C., particularly preferably in the range from −50° C. to 0° C.

In contrast to the polymers PALK the polymers P2 have no olefinically unsaturated C—C bonds. The term olefinically unsaturated C—C bond is to be understood as meaning C—C double bonds which are not constituents of an aromatic π-electron system.

In the polymer P2 at least some of the repeating units comprise at least one polar group. The polar groups are preferably groups comprising a carbonyl group, for example ester, amide, carbonate, urea or urethane groups. In addition, the polar groups may also be carboxyl groups, phosphonic acid groups, sulfonic acid groups, ammonium groups, hydroxy-C₂-C₄-alkyl groups or poly-C₂-C₄-alkylene oxide groups, for example polyethylene oxide, polypropylene oxide or poly(ethylene oxide-co-propylene oxide) groups.

In one preferred group of embodiments of the invention the polymer P2 is selected from polyurethanes, i.e. the polymer P2 comprises urethane groups. The polyurethane may be aliphatic or aromatic. The polyurethane may be unmodified or, to provide improved dispersibility in water, modified with nonionic or ionic polar groups.

Examples of nonionic polar groups include especially poly-C₂-C₄-alkylene oxide groups, for example polyethylene oxide, polypropylene oxide or poly(ethylene oxide-copropylene oxide) groups, in particular polyethylene oxide groups, wherein the poly-C₂-C₄-alkylene oxide groups may be a constituent of the polyurethane backbone or may be in the form of sidechains and preferably have a number-average molecular weight in the range from 200 to 10000 g/mol.

Examples of ionic polar groups include especially anionic groups, for example sulfonate groups, sulfate groups, phosphate groups, phosphonate groups and carboxylate groups, in the acid form or in particular in the salt form and also basic polar groups, for example di-C₁-C₄-alkylamino groups or morpholino groups.

The polyurethanes are typically obtainable by copolymerization of
a) at least one isocyanate component;
b) at least one polyol component and
c) at least one component comprising at least one polar group and at least one isocyanate-reactive group,
   and optionally
d) one or more components d) distinct from components a) to c) and comprising at least one isocyanate-reactive group.

Suitable isocyanate-reactive groups include especially OH-groups, primary amino groups and mercapto groups

With very particular preference the polyurethane is selected from polyester urethanes, in particular the polymer P2 is selected from anionically modified aliphatic polyester urethanes.

The isocyanate component generally comprises at least one diisocyanate and optionally one polyisocyanate having an isocyanate functionality of >2, for example in the range from 2.5 to 5. The isocyanate component may be aliphatic, cycloaliphatic, araliphatic or aromatic. Preferred diisocyanates are aliphatic or cycloaliphatic. These include, for example, tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl) propane, trimethylhexane diisocyanate, the isomers of bis(4-isocyanatocyclohexyl) methane (HMDI) such as the trans/trans, the cis/cis and the cis/trans isomers, and mixtures composed of these compounds. Examples of aromatic and araliphatic diisocyanates include 1,4-diisocyanatobenzene, 2,4-diisocyanatotoluene, 2,6-diisocyanatotoluene, 4,4′-diisocyanatodiphenylmethane, 2,4′-diisocyanatodiphenylmethane and p-xylylene diisocyanate, tetramethylxylylene diisocyanate (TMXDI). Also suitable are mixtures of these isocyanates, for example the mixtures of the respective structural isomers of diisocyanatotoluene and diisocyanatodiphenylmethane, for example a mixture of 80 mol % of 2,4-diisocyanatotoluene and 20 mol % of 2,6-diisocyanatotoluene, mixtures of aromatic isocyanates such as 2,4-diisocyanatotoluene and/or 2,6-diisocyanatotoluene with aliphatic or cycloaliphatic isocyanates such as hexamethylene diisocyanate or IPDI. Examples of polyisocyanates include the biurets and cyanurates of the abovementioned diisocyanates and also oligomeric products of these diisocyanates which in addition to the free isocyanate groups bear further capped isocyanate groups, for example isocyanurate, biuret, urea, allophanate, uretdione or carbodiimide groups.

Preferred diisocyanates are 1-isocyanato-3,5,5-trimethyl-5-isocyanatomethylcyclohexane (IPDI), hexamethylene diisocyanate (HDI) and bis(4-isocyanatocyclohexyl) methane (HMDI).

Useful as the polyol component b) are compounds having at least two hydroxyl groups. These include low molecular weight di- or polyols and polymeric polyols such as polyester diols, polycarbonate diols, polyacrylate polyols and polyether diols and also mixtures thereof. With a view to achieving good film formation and elasticity, the polyol component b) preferably comprises at least one polymeric diol preferably having a number-average molecular weight of about 500 to 10000 g/mol, preferably about 1000 to 5000 g/mol.

The polyurethane preferably comprises at least 40 wt %, particularly preferably at least 60 wt % and very particularly preferably at least 80 wt % of diisocyanates, polyether diols, polycarbonate diols and/or polyester diols.

In one preferred group of embodiments the polyurethane comprises at least one polyester diol, in particular in an amount of at least 10 wt %, particularly preferably at least 30 wt %, in particular at least 40 wt % or at least 50 wt % based on the component B. Polyester diols in particular are employed as synthesis components. When polyester diols are used in admixture with polyether diols or polycarbonate diols, polyester diols preferably account for at least 50 mol %, particularly preferably at least 80 mol %, very particularly preferably 100 mol %, of the mixture of polyester diols and polyether diols.

Examples of suitable polyester polyols include the polyester polyols disclosed, for example, in Ullmanns Enzyklopädie der Technischen Chemie, 4th edition, volume 19, pages 62 to 65. Preference is given to using polyester polyols obtained by reaction of dihydric alcohols with dibasic carboxylic acids. Instead of using free polycarboxylic acids, the polyester polyols may also be produced using the corresponding polycarboxylic anhydrides or the corresponding polycarboxylic esters of lower alcohols or mixtures thereof. The polycarboxylic acids may be aliphatic, cycloaliphatic, araliphatic, aromatic or heterocyclic and may optionally be substituted, for example by halogen atoms, and/or unsaturated. Examples thereof include: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, alkenylsuccinic acid, fumaric acid, dimeric fatty acids. Preference is given to dicarboxylic acids of general formula HOOC—(CH₂)_{y}—COOH where y is a number from 1 to 20, preferably an even number from 2 to 20, for example succinic acid, adipic acid, sebacic acid and dodecanedicarboxylic acid.

Diols useful for producing the polyester polyols include, for example, ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, furthermore diethylene glycol, triethylene glycol, tetraethylene glycol, polyethylene glycol, dipropylene glycol, polypropylene glycol, dibutyleneglycol and polybutylene glycols. Preferred alcohols are those of general formula HO—(CH₂)ₓ—OH where x is a number from 2 to 20, preferably an even number from 2 to 12. Examples thereof include ethylene glycol, butane-1,4-diol, hexane-1,6-diol, octane-1,8-diol and dodecane-1,12-diol. Also preferred are neopentyl glycol and pentane-1,5-diol. These diols may also be used as diols directly for synthesis of the polyurethanes.

Also suitable as component b) are polyester diols based on lactones, specifically homopolymers or copolymers of lactones, preferably terminal hydroxyl-comprising addition products of lactones onto suitable difunctional starter molecules. Useful lactones are preferably those derived from compounds of general formula HO—(CH₂)_{z}—COOH where z is a number from 1 to 20 and one H atom of a methylene unit may also be substituted by a C₁- to C₄-alkyl radical. Examples include ϵ--caprolactone, β-propiolactone, γ-butyrolactone and/or methyl-ϵ-caprolactone and mixtures thereof. Suitable starter components are, for example, the low molecular weight dihydric alcohols referred to hereinabove as synthesis components for the polyester polyols. The corresponding polymers of E-caprolactone are particularly preferred. Lower polyester diols or polyether diols may also be employed as starters for producing the lactone polymers. Instead of the polymers of lactones, the corresponding chemically equivalent polycondensates of the hydroxycarboxylic acids corresponding to the lactones may also be employed.

Also useful as polyol component b) are polycarbonate diols as are obtainable, for example, by reaction of phosgene with an excess of the low molecular weight alcohols referred to as synthesis components for the polyester polyols.

Also useful as polyol component b) are polyether diols. These are in particular polyether diols obtainable by homopolymerization of ethylene oxide, propylene oxide, butylene oxide, tetrahydrofuran, styrene oxide or epichlorohydrin, for example in the presence of BF₃, or by addition of these compounds optionally in admixture or in succession onto starting components having reactive hydrogen atoms, such as alcohols or amines, for example water, ethylene glycol, propane-1,2-diol, propane-1,3-diol, 1,1-bis(4-hydroxyphenyl)propane or aniline. Particular preference is given to polytetrahydrofuran having a molecular weight of 240 to 5000 g/mol and especially 500 to 4500 g/mol. Mixtures of polyester diols and polyether diols may also be used as monomers.

Likewise suitable as polyol component b) are polyhydroxy polyolefins and comparable polyhydroxy polymers based on monoethylenically unsaturated monomers, preferably those having 2 terminal hydroxyl groups, for example α-ω-dihydroxypolybutadiene, α-ω-dihydroxypolymethacrylic ester or α-ω-dihydroxypolyacrylic ester. Such compounds are disclosed in EP-A 622 378 for example. Further suitable polyols are polyacetals, polysiloxanes and alkyd resins.

The polyol component B) often comprises, in addition to the at least one polymeric diol, one or more low molecular weight diols. This makes it possible to increase the hardness and the modulus of elasticity of the polyurethanes. In contrast to the polymeric diols the low molecular weight diols typically have a number-average molecular weight of about 60 to 500 g/mol, preferably of 62 to 200 g/mol. The proportion of any low molecular weight diols present is generally not more than 90 wt %, in particular not more than 70 wt % and especially not more than 50 wt % and is often in the range from 1 to 90 wt %, in particular in the range from 5 to 70 wt % or 10 to 50 wt % in each case based on the total weight of the polyol component. Low molecular weight diols employed are especially the synthesis components of the short-chain alkanediols cited for the production of polyester polyols, particular preference being given to diols having 2 to 12 carbon atoms such as ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentane diols, diethylene glycol, triethylene glycol and dipropylene glycol.

To achieve the water-dispersibility of the polyurethanes, said polyurethanes preferably comprise one or more hydrophilic compounds of component c) incorporated into the polymer which bear at least one isocyanate-reactive group and at least one hydrophilic group or a group which may be converted into a hydrophilic group. The (potentially) hydrophilic groups may be nonionic groups such as polyethylene oxide groups or, preferably, (potentially) ionic hydrophilic groups, for example sulfonate groups, sulfate groups, phosphate groups, phosphonate groups or carboxylate groups. The proportion of component c) generally does not exceed 20 wt % based on the total amount of the polyurethane-forming constituents and is often in the range from 0.1 to 20 wt %, in particular in the range from 0.5 to 10 wt %.

Examples of hydrophilic compounds of component c) include
nonionic compounds such as methylpolyethylene glycols, in particular those having a molecular weight in the range from 150 to 1500 Dalton,
mono- and dicarboxylic acids having two hydroxyl groups, for example dimethylolpropionic acid.
This includes compounds having at least two isocyanate-reactive groups, selected from OH and NH₂ groups, and at least one sulfonic acid group and also the salts thereof, for example 2-[(2-aminoethyl)amino]ethanesulfonic acid and the salts thereof, in particular the alkali metal salts thereof.

Useful as component d) are especially compounds bearing one, two, three or more than three primary amino groups. Preferred compounds of this type include, for example, hydrazine, hydrazine hydrate, ethylenediamine, propylenediamine, diethylenetriamine, triethylenetetramine, 1,2-bis(3-aminoproplyamino)ethane, isophoronediamine, 1,4-cyclohexyldiamine, N-(2-aminoethyl)ethanolamine, N,N-diethylethanolamine, morpholine, piperazine and hydroxyethylpiperazine. The proportion thereof generally does not exceed 20 wt % based on the total amount of the polyurethane-forming constituents and is often in the range from 0.1 to 20 wt %, in particular in the range from 0.5 to 10 wt %.

In very preferred embodiments of the invention the polymer P2 is selected from anionic polyurethanes synthesized from the following constituents a) to c) and optionally d):
a) hexamethylene diisocyanate or isophorone diisocyanate or mixtures thereof;
b) amorphous polyester diol, for example a polyester diol of butyl glycol and/or neopentyl glycol with adipic acid and/or sebacic acid, or a mixture of an amorphous polyester diol and a C₂-C₆-alkylene glycol, for example 1,4-butanediol;
c) an anionic component, for example dimethylolpropionic acid and/or sodium 2-[(2-aminoethyl)amino]ethanesulfonate;
   and optionally
d) at least one further component selected from isophoronediamine, diethylenetriamine, N,N-dimethylethanolamine and mixtures thereof.

In a further preferred embodiment of the invention the polymer P2 is selected from polymers of ethylenically unsaturated monomers M comprising as their main constituent at least one monomer M1 selected from C₁-C₂₀-alkyl esters of acrylic acid, C₁-C₂₀-alkyl esters of methacrylic acid and vinyl esters of aliphatic C₁-C₂₀-carboxylic acids. The monomers M1 in particular account for at least 30 wt %, in particular at least 50 wt %, based on the total amount of the monomers M.

Examples of monomers M1 include
C₁-C₂₀-alkyl esters, in particular C₁-C₁₀-alkyl esters of acrylic acid such as methyl acrylate, ethyl acrylate, n-butyl acrylate, 2-butyl acrylate, tert-butyl acrylate, hexyl acrylate, 2-ethylhexyl acrylate, 2-propylheptyl acrylate, decyl acrylate and stearyl acrylate;
C₁-C₂₀-alkyl esters, in particular C₁-C₁₀-alkyl esters of methacrylic acid such as methyl methacrylate, ethyl methacrylate, n-butyl methacrylate, 2-butyl methacrylate, tert-butyl methacrylate, hexyl methacrylate, 2-ethylhexyl methacrylate, 2-propylheptyl methacrylate, decyl methacrylat and stearyl methacrylate;
vinyl esters of aliphatic carboxylic acids having 1 to 20 carbon atoms, in particular 2 to 18 carbon atoms, for example vinyl acetate, vinyl propionate, vinyl laurate, vinyl stearate, and vinyl esters of branched C₅-C₁₂-carboxylic acids, also vinyl versatate hereinbelow;

Preferred main monomers M1 are C₁-C₁₀-alkyl acrylates, mixtures thereof with C₁-C₁₀-alkyl methacrylates (straight acrylates) and mixtures of C₁-C₁₀-alkyl acrylates with vinyl esters of aliphatic carboxylic acids, in particular with vinyl acetate.

In addition to the abovementioned monomers M1 the polymers P2 may also comprise monomers distinct therefrom incorporated into the polymer. The proportion thereof generally does not exceed 70 wt %, in particular 50 wt %.

These include monoethylenically unsaturated monomers M2 having limited water solubility, for example
vinylaromatic compounds such as styrene, vinyltoluene, α- and p-methylstyrene, α-butylstyrene, 4-n-butylstyrene, 4-n-decylstyrene and in particular styrene; monoethylenically unsaturated nitriles such as acrylonitrile and methacrylonitrile;
vinyl halides, i.e. chlorine-, fluorine- or bromine-substituted ethylenically unsaturated compounds, in particular vinyl chloride and vinylidene chloride;
vinyl ethers, for example vinyl methyl ether or vinyl isobutyl ether. Preference is given to vinyl ethers of alcohols comprising 1 to 4 carbon atoms;
olefinic hydrocarbons having 2 to 8 carbon atoms and one or two olefinic double bonds are ethylene, propylene, butadiene, isoprene and chloroprene.

The monomers distinct from monomers M1 also include monoethylenically unsaturated monomers M3 having elevated water solubility of generally at least 80 g/L at 25° C. and 1 bar, for example
monoethylenically unsaturated monomers having at least one acid group (hydrophilic acidic monomers) such as carboxylic acid, sulfonic acid or phosphonic acid groups and the salts of these monomers, particularly the alkali metal, alkaline earth metal and ammonium salts. Preferred among these are monoethylenically unsaturated monomers having at least one carboxylic acid group. These include, for example, acrylic acid, methacrylic acid, itaconic acid, maleic acid or fumaric acid and aconitic acid. The content of hydrophilic acidic monomers in the polymer P2 is generally not more than 10 wt %. The amount of hydrophilic acidic monomers, if desired, is typically in the range from 0.1 to 10 wt %, in particular in the range from 0.2 to 5 wt %, based on the total amount of the monomers M incorporated into the polymer P2.
neutral monoethylenically unsaturated monomers having an elevated water solubility (neutral hydrophilic monomers) of generally at least 80 g/l (at 25° C.). These include, for example, hydroxyl-comprising monomers, in particular C₂-C₄-hydroxyalkyl (meth)acrylates, esters of (meth)acrylic acid with poly-C₂-C₃-alkylene glycols, monoethylenically unsaturated amides such as (meth)acrylamide and also monoethylenically unsaturated monomers having a urea group or an imidazolinone group such as N-vinylurea or N-(methacryloxy)ethylimidazolin-2-one. The content of neutral hydrophilic monomers in the polymer P2 is generally not more than 20 wt %. The amount of neutral hydrophilic monomers, if desired, is typically in the range from 0.1 to 20 wt %, in particular in the range from 0.2 to 10 wt %, based on the total amount of the monomers M incorporated into the polymer P2.

The concentration of the polymer PALK in the aqueous composition is typically in the range from 2 to 35 wt %, in particular 5 to 25 wt %, based on the total weight of the aqueous composition. The concentration of the polymer P2 in the aqueous composition is typically in the range from 7 to 58 wt %, in particular 15 to 50 wt %, based on the total weight of the aqueous composition. The total content of polymer PALK and polymer P2 in the aqueous composition is preferably in the range from 10 to 60 wt %, in particular in the range from 20 to 55 wt %, based on the total weight of the aqueous composition.

The composition preferably comprises 5 to 60 wt %, preferably 10 to 40 wt %, based on the total content of polymers PALK and P2, of at least one polymer PALK. Accordingly, the composition preferably comprises 40 to 95 wt %, in particular 60 to 90 wt %, based on the total content of polymers PALK and P2, of at least one polymer P2.

The polymers PALK and P2 preferably account for at least 50 wt %, in particular at least 70 wt %, based on the total weight of all nonvolatile constituents in the aqueous compositions according to the invention. Accordingly, nonvolatile constituents distinct from the polymers PALK and P2 account for not more than 50 wt %, in particular not more than 30 wt %.

The aqueous compositions according to the invention typically comprise one or more surface-active substances to stabilize the polymer particles. These may originate from the aqueous polymer dispersions of the polymers PALK/P2 used to produce the aqueous compositions or may be added during dispersal of the polymers PALK and P2.

Suitable surface-active substances include in principle cationic, anionic and nonionic emulsifiers and also cationic, nonionic and anionic protective colloids. Such substances are known to those skilled in the art and may be found, for example, in H. Stache, Tensid-Taschenbuch, Carl-Hanser-Verlag, Munich, Vienna, 1981 and in McCutcheon's, Emulsifiers & Detergents, MC Publishing Company, Glen Rock, 1989. An overview of suitable emulsifiers may be found in Houben-Weyl, Methoden der organischen Chemie, volume XIV/1, Makromolekulare Stoffe, Georg Thieme Verlag, Stuttgart, 1961, pp. 192 to 208. An extensive description of suitable protective colloids may be found in Houben-Weyl, Methoden der organischen Chemie, volume XIV/1, Makromolekulare Stoffe, Georg Thieme Verlag, Stuttgart, 1961, pages 411 to 420.

The surface-active substances employed are often exclusively emulsifiers having number-average molecular weights that, in contrast to the protective colloids, typically do not exceed 1500 g/mol. It will be appreciated that mixtures of emulsifiers and/or protective colloids may also be employed. It will be appreciated that when mixtures of surface-active substances are employed the individual components need to be compatible with one another which may be verified with the aid of just a few preliminary experiments in case of doubt.

Preference among the surface-active substances is given to nonionic emulsifiers, anionic emulsifiers and mixtures thereof and also mixtures of at least one nonionic emulsifier with at least one protective colloid from the group of anionic or nonionic protective colloids and mixtures of at least one anionic emulsifier with at least one protective colloid from the group of anionic or nonionic protective colloids. It is particularly preferable when the surface-active substance comprises at least one nonionic emulsifier or a mixture of at least one nonionic emulsifier with at least one further surface-active substance from the group of anionic emulsifiers, anionic protective colloids and nonionic protective colloids.

The total concentration of surface-active substances is typically in the range from 0.1 to 10 wt % and in particular in the range from 0.2 to 5 wt % based on the total weight of the aqueous composition.

Commonly used nonionic emulsifiers include, for example, ethoxylated mono-, di- and trialkylphenols (degree of ethoxylation: 2 to 50, alkyl radical: C₄ to C₁₂) and ethoxylated fatty alcohols (degree of ethoxylation: 2 to 80; alkyl radical: C₈ to C₃₆). Examples thereof are the Eumulgin® B brands (cetyl-/stearyl alcohol ethoxylates), Dehydol® LS brands (fatty alcohol ethoxylates, degree of ethoxylation: 1 to 10) from COGNIS GmbH and the Lutensol® A brands (C₁₂C₁₄-fatty alcohol ethoxylates, degree of ethoxylation: 3 to 8), Lutensol® AO brands (C₁₃C₁₅-oxoalcohol ethoxylates, degree of ethoxylation: 3 to 30), Lutensol® AT brands (C₁₆C₁₈-fatty alcohol ethoxylates, degree of ethoxylation: 11 to 80), Lutensol® ON brands (C₁₀-oxoalcohol ethoxylates, degree of ethoxylation: 3 to 11) and the Lutensol® TO brands (C₁₃-oxoalcohol ethoxylates, degree of ethoxylation: 3 to 20) from BASF SE. It is alternatively possible to employ low molecular weight, random and water-soluble ethylene oxide and propylene oxide copolymers and derivatives thereof, low molecular weight, water-soluble ethylene oxide and propylene oxide block copolymers (for example Pluronic® PE having a molecular weight of 1000 to 4000 g/mol and Pluronic® RPE from BASF SE having a molecular weight of 2000 to 4000 g/mol) and derivatives thereof.

Customary anionic emulsifiers include, for example, alkali metal and ammonium salts of alkyl sulfates (alkyl radical: C₈ to C₁₂), of sulfuric monoesters of ethoxylated alkanols (degree of ethoxylation: 4 to 30, alkyl radical: C₁₂ to C₁₈) and of ethoxylated fatty alcohols (degree of ethoxylation: 3 to 50, alkyl radical: C₄ to C₁₂), of alkylsulfonic acids (alkyl radical: C₁₂ to C₁₈), and of alkylarylsulfonic acids (alkyl radical: C₉ to C₁₈).

Useful anionic emulsifiers further include compounds of general formula (II)

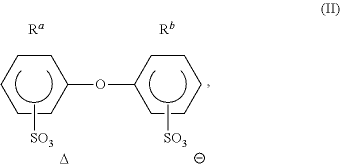

where R^{a} and R^{b} represent H atoms or C₄- to C₂₄-alkyl but are not simultaneously H atoms and Δ and Θ may be alkali metal ions and/or ammonium ions. In the general formula (II) R^{a} and R^{b} preferably represent linear or branched alkyl radicals having 6 to 18 carbon atoms, in particular having 6, 12 and 16 carbon atoms, or H where R^{a} and R^{b} may not both be an H atom simultaneously. Δ and Θ are preferably sodium, potassium or ammonium, sodium being particularly preferred. Particularly advantageous compounds (II) are those in which Δ and Θ are sodium, R^{a} is a branched alkyl radical having 12 carbon atoms and R^{b} is an H atom or R^{a}. Technical-grade mixtures comprising a proportion of the monoalkylated product of from 50 to 90 wt %, for example Dowfax® 2A1 (brand of Dow Chemical Corp.), are often used. Compounds (II) are commonly/generally known, for example from U.S. Pat. No. 4,269,749, and are commercially available.

Suitable cation-active emulsifiers are generally C₆- to C₁₈-alkyl-, -aralkyl- or -heterocyclyl-containing primary, secondary, tertiary or quaternary ammonium salts, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts. Examples include dodecylammonium acetate or the corresponding hydrochloride, the chlorides or acetates of the various 2-(N,N,N-trimethylammonium)ethyl paraffinic acid esters, N-cetylpyridinium chloride, N-laurylpyridinium sulfate and N-cetyl-N,N,N-trimethylammonium bromide, N-dodecyl-N,N,N-trimethylammonium bromide, N-octyl-N,N,N-trimethlyammonium bromide N,N-distearyl-N,N-dimethylammonium chloride and also the Gemini surfactant N,N′-(lauryldimethyl)ethylenediamine dibromide. Numerous further examples may be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

Suitable neutral protective colloids include, for example, polyvinyl alcohols, Polyalkylene glycols, polyvinyl pyrrolidones and derivatives of cellulose, starch and gelatin.

Useful anionic protective colloids, i.e. protective colloids whose dispersing component has at least one negative electrical charge, include, for example, polyacrylic acids and polymethacrylic acids and their alkali metal salts, copolymers comprising acrylic acid, methacrylic acid, itaconic acid, 2-acrylamido-2-methyl-propanesulfonic acid, 4-styrenesulfonic acid and/or maleic anhydride and their alkali metal salts and also alkali metal salts of sulfonic acids of high molecular weight compounds, for example polystyrene.

Suitable cationic protective colloids, i.e. protective colloids whose dispersing component has at least one positive electrical charge include, for example, the N-protonated and/or -alkylated derivatives of homo- and copolymers comprising N-vinylpyrrolidone, N-vinylcaprolactam, N-vinylformamide, N-vinylacetamide, N-vinylcarbazole, 1-vinylimidazole, 2-vinylimidazole, 2-vinylpyridine, 4-vinylpyridine, acrylamide, methacrylamide, amine-group-bearing acrylates, methacrylates, acrylamides and/or methacrylamides.

The aqueous compositions according to the invention may optionally comprise one or more further constituents typically employed for processing. Examples of further constituents include rheology modifiers, wetting assistants, organic fillers, inorganic fillers, stabilizers and colorants, for example color-giving pigments. The content of these additions is known to those skilled in the art.

The invention further provides a process for producing the aqueous compositions according to the invention. This typically comprises mixing an aqueous dispersion of the polymer PALK with an aqueous dispersion of the polymer P2. An alternative option comprises emulsifying a solution of the polymer P2 in a water-miscible organic solvent, for example in a ketone, such as acetone or methyl ethyl ketone, in an aqueous dispersion of the polymer PALK and subsequently removing the organic solvent, for example by azeotropic distillation. The aqueous compositions according to the invention are preferably produced by mixing aqueous dispersions of the polymers PALK and P2.

As previously intimated the aqueous dispersions of the polymer PALK and the production thereof are known to those skilled in the art. The polymers P2 and the aqueous dispersions thereof are likewise known to those skilled in the art. The polymers P2 and the aqueous dispersions thereof are moreover commercially available.

Provided that the polymer P2 is a polyurethane said polymer is typically produced by reaction of the abovementioned components a) to c) and optionally d), the quantitative ratios typically being chosen such that the molar ratio of the isocyanate groups of component a) to the number of isocyanate-reactive groups in components b), c) and optionally d) is in the range from 1: 1.1 to 1.1: 1. Production is preferably carried out in an aprotic organic solvent, for example a ketone having 3 to 6 carbon atoms such as acetone, methyl ethyl ketone, diethyl ketone or cyclohexanone , an aliphatic carboxylic ester, for example a C₁-C₆-alkyl ester or C₁-C₃-alkoxy-C₂-C₄-alkylester of acetic acid, such as methyl acetate, ethyl acetate, methoxyethyl acetate etc. The polymer solution obtained may then be emulsified in water in a manner known per se and the organic solvent removed, for example by azeotropic distillation.

Provided that the polyamide P2 is constructed from polymerized ethylenically unsaturated monomers M, the aqueous dispersion of the polymer P2 is generally an emulsion polymer. Emulsion polymers are familiar to those skilled in the art and are produced, for example, in the form of an aqueous polymer dispersion by free-radically initiated aqueous emulsion polymerisation of ethylenically unsaturated monomers. This method has been described many times previously and is thus sufficiently well known to the person skilled in the art [cf., for example, Encyclopedia of Polymer Science and Engineering, Vol. 8, pages 659 to 677, John Wiley & Sons, Inc., 1987; D.C. Blackley, Emulsion Polymerisation, pages 155 to 465, Applied Science Publishers, Ltd., Essex, 1975; D.C. Blackley, Polymer Latices, 2nd Edition, Vol. 1, pages 33 to 415, Chapman & Hall, 1997; H. Warson, The Applications of Synthetic Resin Emulsions, pages 49 to 244, Ernest Benn, Ltd., London, 1972; J. Piirma, Emulsion Polymerisation, pages 1 to 287, Academic Press, 1982; F. Holscher, Dispersionen synthetischer Hochpolymerer, pages 1 to 160, Springer-Verlag, Berlin, 1969 and patent document DE-A 40 03 422]. The free-radically initiated aqueous emulsion polymerization is typically effected by dispersedly distributing the ethylenically unsaturated monomers, generally with co-use of dispersing aids, such as emulsifiers and/or protective colloids, in aqueous medium and polymerizing them using at least one water-soluble free-radical polymerization initiator. Frequently, the residual contents of unconverted ethylenically unsaturated monomers in the aqueous polymer dispersions obtained are reduced using chemical and/or physical methods likewise known to a person skilled in the art [see for example EP-A 771328, DE-A 19624299, DE-A 19621027, DE-A 19741184, 5 DE-A 19741187, DE-A 19805122, DE-A 19828183, DE-A 19839199, DE-A 19840586 and 19847115], the polymer solids content is adjusted to a desired value by diluting or concentrating, or the aqueous polymer dispersion has added to it further customary added substances, for example bactericidal foam- or viscosity-modifying additives.

Examples of commercially available aqueous dispersions of polymers P2 constructed from ethylenically unsaturated monomers M include the Acronal range from BASF SE, for example Acronal 500 D and Acronal S 504, the Mowilith range from Celanese Emulsions GmbH, for example Mowilith LDM 1871 and Mowilith DM 765, the Vinnapas range from Wacker, for example Vinnapas 192 and the Primal range from Dow, for example Primal AC 412.

Examples of commercially available aqueous dispersions of polyurethanes P2 include the Astacin range and a number of Joncryl dispersions from BASF SE, for example Astacin Finish PE oder Joncryl FLX 5200, the Impranil range from Bayer Material-Science, for example Impranil DLV/1 and Impranil DL 1380 and the NeoRez range from DSM, for example NeoRez 1013.

The invention also relates to polymer powders obtainable by drying an aqueous composition. Drying may be carried out similarly to known processes for producing polymer powders from aqueous polymer dispersions, for example by spray drying or freeze drying. To promote powder formation and to reduce agglomerate formation, drying aids, for example the abovementioned protective colloids, and/or free-flow aids and antiagglomeration agents may be added.

The aqueous compositions according to the invention form a film during drying, i.e. the polymer particles in the aqueous compositions coalesce during drying and form a polymer film having advantageous mechanical properties, for example high elasticity coupled with high strength, in particular breaking strength or tear strength. The polymer films exhibit a good barrier action, in particular toward gases and specifically toward oxygen or oxygenous gas mixtures such as air. Said films are accordingly suitable for producing coating or sheetings having a barrier action.

The invention further provides a polymer sheeting obtainable using an aqueous composition according to the invention. To this end, the aqueous composition is applied as a wet film onto a carrier and dried. This causes a layer comprising the polymers PALK and P2 to form on the carrier. This layer may be left on the carrier as a coating or may be detached from the carrier as a self-supporting sheeting.

The polyalkenamer in the polymer sheeting may be in at least partly oxidized form. The degree of oxidation of the polymers may be determined by infrared spectroscopy. Suitable therefor are, for example, the C═O, C—O and OH signals. The degree of oxidation may preferably be calculated as the quotient of the extinctions for the carbonyl group and for the C—C double bond.

Oxidation of the polymer sheeting may be effected, for example, by storage in an oxygenous environment, preferably while employing radiant energy, thermal energy or oxidation accelerants or a combination thereof. Oxidation of the polymer PALK may be effected, for example, in air under daylight at room temperature (ca. 20-25° C.). Oxidation may be accelerated by radiant energy, thermal energy or oxidation accelerants. Useful oxidation accelerants include, for example, chemical oxidation accelerants such as transition metals and transition metal compounds known for this purpose, in particular those of iron, zirconium, manganese, zinc or cobalt.

By way of example, suitable coating machines may be used to apply the aqueous composition onto a carrier sheeting made of a plastics material. When web-form materials are used, the aqueous dispersion is typically applied from a trough via an application roll and leveled using an airbrush. Other ways to apply the coating include for example the reverse gravure process, spraying processes or a doctor roller or other coating processes known to those skilled in the art. The carrier substrate has a coating on at least one side, i.e. it may have a coating on one or both sides. To still further improve adhesion to a sheeting, the carrier sheeting may first be subjected to corona treatment or alternatively adhesion promoters, for example polyethyleneimines, may be employed. The amounts applied to the sheetlike materials are, for example, preferably 1 to 800 g (of polymer solids) per m², preferably 1 to 400 g/m² or 5 to 200 g/m². After the coating compositions have been applied to the carrier substrates, volatile constituents are evaporated. For this, in the case of a continuous process, the material may be passed through a dryer duct, which may be equipped with an infrared irradiating device, for example. The coated and dried material is then led over a chill roll and finally wound up.

The amount of the aqueous composition applied to the sheeting is generally chosen such that the dried coating has a thickness of at least 1 μm, in particular at least 5 μm and preferably 1 to 400 μm, particularly preferably 5 to 200 μm. The thickness of the carrier sheetings is determined by the desired application and is generally in the range from 10 μm to 1 cm. The polymer PALK at the surface of the layer is preferably in at least partly oxidized form. In the thicker layers the core of the coating may comprise unoxidized polymer PALK.

The invention further provides for the use of the aqueous compositions according to the invention for the production of barrier coatings.

The invention further provides a coating obtainable by a process comprising
(a) applying an aqueous composition according to the invention onto the surface of a sheetlike carrier and
(b) removing the volatile constituents of the composition to obtain a dry coating.

In one preferred embodiment of the invention the polymer PALK in the barrier sheeting or barrier coating is in at least partly oxidized form. The term “oxidized” is to be understood as meaning that the polymer PALK bears at least one oxygen-containing group.

The aqueous composition according to the invention may be applied as a spray film or a spread film, for example by roller, doctor blade, airbrush, or cast spreading processes. The amount of the aqueous composition applied to the carrier is generally chosen such that the dried coating has a thickness of at least 1 μm, in particular at least 5 μm and preferably 1 to 400 μm, particularly preferably 1 to 200 μm.

Preference is given to a coating obtainable by a process comprising:
(a) applying an aqueous composition according to the invention onto the surface of a sheetlike carrier,
a1) wherein the composition may optionally be applied in one or more steps and
a2) wherein the composition may optionally be effected by one or more methods selected from soaking, impregnating, spray application, spread application, coating and calendaring;
b) removing the aqueous constituents of the composition to obtain a film,
b1) wherein the removal of the aqueous constituents may optionally be effected by drying under ambient conditions;
c) optionally oxidizing the coating,
c1) wherein oxidation may optionally be effected by storage in an oxygenous environment, preferably while employing radiant energy, thermal energy, oxidation accelerants or a combination thereof.

In the process the steps a), b) and optionally c) may be performed one or more times and the steps may each be implemented with identical or different variants.

As described above the oxidation in step c) may be effected, for example, by storage in an oxygenous environment, preferably while employing radiant energy, thermal energy or oxidation accelerants or a combination thereof.

In addition to the abovementioned uses the aqueous compositions according to the invention are also suitable for the following applications: Production of adhesives, sealants, renders, papercoating slips, fiber webs, paints and impact modifiers and also for sand consolidation, textile finishing, leather finishing and for modifying mineral binders and plastics.

Preference is also given to the use of an aqueous composition according to the invention comprising at least one polymer PALK and at least one polymer P2 for finishing rubber materials and for producing barrier coatings on rubber substrates.

The rubber constituents of the rubber material/rubber substrate may be selected, for example, from diene rubber, natural rubber, butyl rubber, synthetic polyisoprene, polybutadiene, styrene-butadiene copolymer, isoprene-butadiene rubber, styrene-isoprene-butadiene rubber, acrylonitrile-butadiene rubber, ethylene-propylene rubber and chloroprene rubber. The rubber material is preferably a constituent of a pneumatic tire, in particular a tire inner layer of a pneumatic tire or a tire carcass of a pneumatic tire.

In one embodiment the rubber materials themselves are finished with one of the aqueous compositions according to the invention. In another embodiment constituents of a rubber-containing object, in particular of pneumatic tires, are finished with the barrier material and introduced into the rubber-containing object, preferably pneumatic tires. For example the textile cord insert in pneumatic tires may be finished with the aqueous compositions according to the invention.

The invention also provides a process for finishing a rubber material, wherein at least one of the aqueous compositions described herein is applied onto or incorporated into the rubber material. Finishing may be effected by, for example, by one or more of the following methods: Impregnating by soaking, by spray application or by spread application, coating, calendaring. The compositions employed for coating may comprise further added/auxiliary components, for example thickeners for adjusting rheology, wetting assistants, organic or inorganic fillers or binders.

It is preferable when at least one aqueous composition according to the invention is applied to a carrier substrate. As the composition dries a film is formed on the carrier substrate.

The invention also relates to pneumatic tires comprising a rubber material finished or coated with a composition according to the invention. Composition may have been applied onto or incorporated into the rubber material by one or more of the following methods:
application onto at least a portion of the surface or onto the entire surface of the tire inner layer;
introduction into the material of the tire inner layer;
as a film, as a carrierless sheeting or as a coating of a sheeting carrier, wherein the films or sheetings may have been introduced into the tire interior in addition to a rubber-based tire inner layer, or as replacement for a tire inner layer;
as a binder or coating for a fiber cord insert of the pneumatic tire;
as a laminate between two or more carrier sheetings that has been introduced into the tire interior.

Application as a film may be as a spray film or a spread film, for example by roller, doctor blade, airbrush, or cast spreading processes. Application may also be as a sheeting which serves as a carrier and is then bonded or crosslinked (vulcanized) with the carcass. Suitable sheeting carriers include, for example, rubber, polyolefin, polyester, polyamide or polyurethane sheeting carriers.

Alternatively, the aqueous composition may also be used to produce a laminate between two carrier sheetings, the laminate then being bonded or crosslinked with the carcass.

The rubber materials may also be finished using self-supporting sheetings that have been produced in the abovedescribed fashion from the aqueous compositions according to the invention.

The substrates coated in accordance with the invention show exceptional gas barrier action, in particular toward oxygen and oxygenous gas mixtures such as air.

### EXAMPLES

The solids contents of the aqueous dispersions were generally determined by drying a defined amount of the aqueous polymer dispersion (about 0.8 g) to constant weight at a temperature of 130° C. using a Mettler Toledo HR73 moisture analyzer. Two measurements were carried out in each case. The reported values are the average values of these measurements.

The density and the average particle diameter of the polymer particles were determined as described in “Analytical Ultracentrifugation of polymers and nanoparticles” (Springer Laboratory 2006, W. Mächtle and L. Barger) by analytical ultracentrifugation (AUC) with turbidity optics on a Beckman-Coulter Optima XL-A/I instrument. Density determination comprises measuring sedimentation rates under otherwise identical conditions in three solvents of different densities (H₂O, H₂O/D₂O (1:1) and D₂O). Particle size may be determined from the sedimentation rate.

Glass transition temperature (Tg) was determined using a TA Instruments DSC Q2000 V24.4 Build 116 differential scanning calorimeter. A heating rate of 20 K/min was employed.

Elongation at break values were determined by tensile tests on a Z050 tester from Zwick GmbH & Co in conformance with the following conditions and parameters: Standard ISO 527-2, geometry DIN 53504 S3A, temperature 23° C., relative atmospheric humidity 50%, force sensor 50 N, testing speed 200 mm/min, clamped length 25 mm, measuring length 25 mm.

The oxygen permeabilities were measured according to ASTM D 3985 (for measurements at 0% relative atmospheric humidity) and ASTM F 1927 (for measurements at 85% relative atmospheric humidity) with a MOCON OXTRAN® 2/21 which operates according to the carrier-gas method. (In the carrier-gas method the masked sheeting samples (without carrier material) are installed in an airtight cell with a cavity on each side). A carrier gas (95% N₂ and 5% H₂) is routed past one side of the sample and the measuring gas (100% O₂) past the other side, at atmospheric pressure. The measuring gas diffusing through the sample is taken up by the carrier gas and is passed to a coulometric sensor. This allows determination of oxygen concentration as a function of time. All measurements were carried out at a temperature of 23° C. and a defined relative atmospheric humidity. Both sides of the sample were subjected to the defined atmospheric humidity. Determinations were carried out in duplicate for each sample. For the measuring process the transmission rate (cm³/(m²*day)) of the sample was normalized with the average thickness of the sheeting, which was determined at five different locations, to 1 mm and 1 bar. This normalization gave the permeation rate.

The aqueous polymer dispersions were produced using the metal carbene complex dichloro-1,3-bis(2,6-dimethyl-4-dimethylaminophenyl)imidazolidin-2-ylidene-bis(4-dimethylaminopyridine)(phenylthio)methyleneruthenium(II) (metal carbene complex 1).

The production of this catalyst is described in WO 2012/076426.

### Example 1

### Production of Polyalkenamer Dispersion 1 (PALK-D1)

A mixture composed of 107.3 g of deionized water, 13.8 g of an aqueous solution (20 wt %) of a C16/C18-fatty alcohol polyethoxylate (Lutensol® AT 18 from BASF SE), 2.6 g of n-hexadecane, 8.9 g of norbornene and 43.4 g of cis-cyclooctene were weighed into a 250 ml glass flask with a magnetic stirrer at 20° C. to 25° C. (room temperature) under a nitrogen atmosphere and the mixture was subjected to vigorous stirring for one hour to form a homogeneous monomer macroemulsion. The monomer macroemulsion formed was subsequently homogenized for 10 minutes using a UP 400s ultrasound processor (Sonotrode H7, 100% power). The monomer emulsion obtained was subsequently transferred under a nitrogen atmosphere to a temperature-controllable 500 ml glass flask fitted with a stirrer, thermometer, reflux cooler and feed vessels and heated to 75° C. with stirring. With stirring and while maintaining this temperature, a solution formed from 60 mg of metal carbene complex 1 and 8.9 g of a 0.5 molar aqueous hydrochloric acid solution was added to the monomer miniemulsion over 45 minutes and the polymerization mixture obtained was stirred for 1 hour at this temperature. The obtained aqueous polymer dispersion was then cooled to room temperature and filtered through a 150 μm filter. The obtained aqueous polymer dispersion had a solids content of 29.7 wt %. Determination revealed the average particle size to be 455 nm, the glass transition temperature of the obtained polymer to be −69° C. and the density to be 0.879 g/cm³.

### Example 2

### Production of Polyalkenamer Dispersion 2 (PALK-D2)

Example 2 was carried out similarly to example 1 except that 11.9 g of dicyclopentadiene and 40.5 g of cis-cyclooctene were employed instead of 8.9 g of norbornene and 43.4 g of cis-cyclooctene. The obtained aqueous polymer dispersion had a solids content of 29.9 wt %. Determination revealed the average particle size to be 401 nm, the glass transition temperature of the obtained polymer to be −59° C. and the density to be 0.895 g/cm³.

### Example 3

### Production of Polyalkenamer Dispersion 3 (PALK-D3)

Example 3 was carried out similarly to example 1 except that 22.9 g of dicyclopentadiene and 29.2 g of cis-cyclooctene were employed instead of 8.9 g of norbornene and 43.4 g of cis-cyclooctene. The obtained aqueous polymer dispersion had a solids content of 29.7 wt %. Determination revealed the average particle size to be 385 nm, the glass transition temperature of the obtained polymer to be −40° C. and the density to be 0.940 g/cm³.

### Example 4

### Production of Polyalkenamer Dispersion 4 (PALK-D4)

Example 4 was carried out similarly to example 1 except that 52.6 g of cis-cyclooctene were employed instead of 8.9 g of norbornene and 43.4 g of cis-cyclooctene. The obtained aqueous polymer dispersion had a solids content of 29.7 wt %. Determination revealed the average particle size to be 339 nm, the glass transition temperature of the obtained polymer to be −85° C. and the density to be 0.866 g/cm³.

Production of the Polymer Sheetings

The polymer sheetings were produced using polymer dispersions and mixtures of polymer dispersions. In the case of mixtures the polyalkenamer dispersion was pH-adjusted to a pH between 7 and 8 with a 25% aqueous ammonia solution prior to mixing. Oxidation accelerant (7 wt % based on the solids content of the polyalkenamer dispersion) was emulsified in water. The emulsion of the oxidation accelerant and the polymer dispersion or the mixture of the polymer dispersions were combined. The solids content of the overall mixture was between 15% and 20%. The mixture was then filtered through a 125 μm filter. The polymer sheeting was produced by pouring out the mixture into a silicone mold. The poured-out film was dried for 48 h at 25° C. and then conditioned for 12 hours at a temperature of 100° C. The compositions of the sheetings produced is reported in table 1.

Polyurethane Dispersion 1 (PU-D1)

PU-D1 is an aqueous anionic polyester-polyurethane dispersion which was produced from an amorphous polyester diol, 1,4-butanediol, hexamethylene diisocyanate, isophorone diisocyanate, sodium 2-[(2-aminoethyl)amino]ethanesulfonate, isophoronediamine and diethylenetriamine. The aqueous polymer dispersion had a solids content of 40.0 wt %. Determination revealed the average particle size to be 84 nm, the density to be 1.119 g/cm³ and the glass transition temperature of the soft phase of the obtained polymer to be −45° C.

Polyurethane Dispersion 2 (PU-D2)

PU-D2 is an aqueous, anionic aliphatic polyurethane dispersion which was produced from an amorphous polyester diol, 1,4-butanediol, isophorone diisocyanate, dimethylolpropionic acid, isophoronediamin, N,N-diethylethanolamine and diethylenetriamine. The aqueous polymer dispersion had a solids content of 36.5 wt %. Determination revealed the average particle size to be 38 nm, the density to be 1.154 g/cm³ and the glass transition temperature of the soft phase of the obtained polymer to be −21° C.

Polyacrylate Dispersion 1 (PAc-D1)

PAc-D1 is an aqueous dispersion of an acrylic ester copolymer with co-use of vinyl acetate which was produced from n-butyl acrylate and vinyl acetate. The aqueous polymer dispersion had a solids content of 50.0 wt %. Determination revealed the average particle size to be 175 nm, the density to be 1.119 g/cm³ and the glass transition temperature of the obtained polymer to be −6° C.

Oxidation Accelerant

The oxidation accelerant employed was Octa-Soligen® 144 aqua from OMG Borchers.

Table 1 shows that sheetings made of polyalkenamer dispersions have a very good barrier action for oxygen but exhibit a very low extensibility (elongation at break <50%). Table 1 further shows that sheetings made of formulations comprising up to 20 wt % of polyalkenamer dispersions surprisingly exhibit both a low permeability and a good flexibility (elongation at break >150%).

TABLE 1
Composition of the sheetings and properties thereof

| | | | | | | | | | O₂ Permeability at |
|---|---|---|---|---|---|---|---|---|---|
| | | | | | | | | Elongation | 23° C. and 0% reletive |
| | | | | | | | | at break ^{(b)} | atmopheric humidity ^{(c)} |
| Sheeting ^{(a)} | PALK-D1 | PALK-D2 | PALK-D3 | PALK-D4 | PU-D1 | PU-D2 | PAc-D1 | (%) | (cm³ mm/m²/day/bar). |
| 1 | 100 | | | | | | | 39 | 3.7 |
| 2 | | 100 | | | | | | 41 | 5.9 |
| 3 | | | 100 | | | | | 6 | 5.0 |
| 4 | | | | 100 | | | | 33 | 0.6 |
| 5 | 50 | | | | 50 | | | 174 | 1.2 |
| 6 | 30 | | | | 70 | | | 447 | 1.3 |
| 7 | 20 | | | | 80 | | | 454 | 0.4 |
| 8 | 10 | | | | 90 | | | 691 | 110 |
| 9 | | 30 | | | 70 | | | 225 | 0.3 |
| 10 | | 20 | | | 80 | | | 195 | 2.3 |
| 11 | | | 20 | | 80 | | | 207 | 0.1 |
| 12 | | | | 30 | 70 | | | 293 | 0.1 |
| 13 | | | | 20 | 80 | | | 677 | 2.0 |
| 14 | | 30 | | | | | 70 | 196 | 0.7 |
| 15 | 20 | | | | | 80 | | 182 | 0.9 |
| C1 | | | | | 100 | | | | 230 |
| C2 | | | | | | | 100 | | 410 |

^{(a)} The polyalkenamer dispersions were pH adjusted to pH 7-8 with ammonia (25% in water) prior to mixing. Prior to sheeting production polymer dispersions were mixed with an aqueous emulsion of the oxidation accelerant (7 wt % oxidation accelerant based on the solids content of the polyalkenamer dispersion).
^{(b)} Measured according to ISO 527-2 and DIN 53504 S3A
^{(c)} Measured at 23° C. and 0% relative atmospheric humidity according to ASTM D 3985.

1. An aqueous composition, comprising:
a) a polymer PALK in a form of dispersed polymer particles, wherein the polymer PALK is obtained by ring-opening metathesis polymerization of at least one cyclic olefin monomer, and
b) a polymer P2 in a form of dispersed polymer particles, wherein the polymer P2 comprises no olefinically unsaturated C—C bond and has repeating units bearing at least one polar group.

2. The aqueous composition according to claim 1,
wherein the polymer PALK has at least one of:
i) a volume-average particle size determined by analytical ultracentrifugation of from 200 to 1000 nm,
ii) a density of from 0.75 to 0.97 g/cm³, and
iii) a glass transition temperature Tg of from −100° C. to −20° C.

3. The aqueous composition according to claim 1,
wherein the polymer PALK is obtained by ring-opening metathesis polymerization of at least one cyclic olefin monomer, comprising
i) a first olefin monomer O1, which is a monocyclic olefin monomer having at least one endocyclic C—C double bond, there being no hydrogen-bearing tertiary carbon atom in an alpha position to the at least one endocyclic C—C double bond, and
ii) optionally a second olefin monomer O2 selected from the group consisting of
a monocyclic olefin monomer O2.1 having an endocyclic double bond, there being a hydrogen-bearing tertiary carbon atom in at least one alpha position to the endocyclic double bond;
a bicyclic olefin monomer O2.2 having at least one endocyclic double bond and two hydrocarbon rings, and
a polycyclic olefin monomer O2.3 having at least one endocyclic double bond and at least 3 hydrocarbon rings.

4. The aqueous composition according to claim 1,
wherein the polymer P2 has at least one of:
i) a volume-average particle size determined by analytical ultracentrifugation of from 20 to 500 nm,
ii) a density of from 1.0 to 1.5 g/cm³, and
iii) a glass transition temperature Tg of from −70° C. to 30° C.

5. The aqueous composition according to claim 1,
wherein in the polymer P2, the at least one polar group of the repeating units comprises a carbonyl group which is in a form of an ester, amide, carbonate, urea or urethane group.

6. The aqueous composition according to claim 1,
wherein the polymer P2 is selected from the group consisting of a polyurethane and a polymer of an ethylenically unsaturated monomer M comprising, as a main constituent, a monomer M1 selected from the group consisting of a C₁-C₂₀-alkyl ester of acrylic acid, and a C₁-C₂₀-alkyl ester of methacrylic acid.

7. The aqueous composition according to claim 1,
wherein the polymer P2 is an anionically modified aliphatic polyester urethane.

8. The aqueous composition according to claim 1, comprising:
a) 5 to 60 wt %, of the polymer PALK
b) 40 to 95 wt %, of the polymer P2,
based on a total content of polymers PALK and P2.

9. The aqueous composition according to claim 1, further comprising: an oxidation accelerant.

10. The aqueous composition according to claim 1,
wherein the polymer PALK and the polymer P2 account for at least 50 wt % of nonvolatile constituents in the aqueous composition.

11. A polymer powder obtained by a process comprising drying the aqueous composition according to claim 1.

12. A process for producing the aqueous composition according to claim 1, the process comprising:
mixing at least one aqueous dispersion PALK-D comprising the polymer PALK with at least one aqueous dispersion P2-D comprising the polymer P2.

13. A coating or polymer sheeting having a barrier action produced with the aqueous composition according to claim 1.

14. The coating or polymer sheeting according to claim 13,
wherein the polymer PALK is at least partly oxidized.

15. A process for producing at least one coating having a barrier action, the process comprising:
a) applying the aqueous composition according to claim 1 onto a surface of a sheetlike carrier, and
b) removing volatile constituents of the aqueous composition, thereby obtaining a coating.

16. A barrier coating or a barrier sheeting, comprising the aqueous composition of claim 1.
